(19) United States
(12) Patent Application Publication
(10) Pub. No.: US 2023/0203358 A1
(43) Pub. Date: Jun. 29, 2023

(54) Phase change polysaccharide-based bio-complexes with tunable thermophysical properties and preparation method thereof

(71) Applicant: Aalto University Foundation sr, Aalto (FI)

(72) Inventors: Ari Seppälä, Espoo (FI); Roza Yazdani, Espoo (FI)

(21) Appl. No.: 17/928,294

(22) PCT Filed: May 31, 2021
(86) PCT No.: PCT/FI2021/050394

§ 371 Date: Nov. 29, 2022

(30) Foreign Application Priority Data
May 29, 2020 (FI) 20207095

(51) Int. Cl. C09K 5/06

(52) U.S. Cl. CPC C09K 5/063

(57) ABSTRACT

Temperature responsive phase change bio-complexes (PCBC) with tunable physicochemical properties and preparation method thereof. The phase change bio-complexes consist of a phase change material (PCM) (or mixture of PCMs) and a polysaccharide (or combination of polysaccharides). The polysaccharide provides mechanical and thermal stabilization and the PCM provides temperature responsive properties to the complexation. In order to undergo complexation with polysaccharides, sugar alcohols and salt hydrates classifications of PCMs are preferred which results in compatibility and homogeneity of the bio-complexes. Addition of multivalent cations (water soluble salts) and/or salts of an acid tunes the thermophysical properties of the bio-complexes such as tunable temperature and latent heat of fusion and structural and thermal stability. These environmentally benign phase change bio-complexes can be applied in different form-stable formats such as powdered, films, pellets, sheets, beads, sponge etc. for thermal management purposes including thermal energy storage and thermal protection via heat absorbing-releasing, for instance, in building, packaging, electronics, temperature sensitive items (black boxes) and wearables.

### FIELD OF INVENTION

This invention relates to phase change materials (PCMs) and the preparation method thereof. More particularly, the present invention relates to biocompatible complexes of phase change materials and polysaccharides and to a method for preparing complexes comprising PCMs and polysaccharides.

### BACKGROUND

Polysaccharides, as carbohydrates consisting of long chains of simple sugars, are derived from renewable sources, such as plant cell walls and microorganisms, and are utilized for diverse applications in different industries, to name a few food, textile, paper, cosmetics and biomedical. They have been also employed as water superadsorbents and adsorbents for the separation of substances present in aquatic environment, i.e. water treatment. The industrial use of these versatile carbohydrates relies on their functional features e.g. stabilizing, thickening, chelating, emulsifying, encapsulating, swelling and gel forming properties. Intrinsic characteristics of biocompatibility, biodegradability, bioadhesivity, nontoxicity, natural-availability and cost-effectiveness further account for the increasing interest on environmental applications of polysaccharides [1].

Polysaccharides are categorized as storage, e.g. starch and guar gum, structural, e.g. cellulose and chitin, and bacterial, e.g. alginic acid (alginate) and xanthan gum. For example, alginate, derived from different species of seaweed (brown algae), is a polyanionic polysaccharide, formed from linear chains of guluronic acid and mannuronic acid residues. Alginate is vastly utilized for its unique bio-colloidal properties such as solution thickening, suspension/emulsion stabilizing, and gelling in e.g. food, textile, paper, and pharmaceutical industries. Furthermore, it can undergo complexation with di/multivalent cations such as calcium and magnesium, which results in mechanical/structural improvement [2, 3].

Xanthan gum is another bacterial, acidic polysaccharide secreted by Xanthomonas campestris bacteria (industrially produced from glucose through fermentation by the microorganism). It is made of the β-D-(1, 4)-glucose backbone chain with a trisaccharide side-branch that consists of β-D-(1, 2)-mannose, β-D-(1, 4)-glucuronic acid, and β-d-mannose. Xanthan gum shows high stability under harsh conditions such as acidic, high salinity, high shear stress, and thermal hydrolysis, better than many synthetic polymers, possibly due to its ordered helical structure [4].

Starch is an abundant and inexpensive storage polysaccharide. Starch and cellulose consist of glucose units, linked through, respectively, α-(1, 4)- and β-(1, 4)-glycosidic bonds [1, 5]. Starch contains linear amylose units and highly branched non-linear amylopectin. Cellulose and chitin are, respectively, the first and second most abundant structural polysaccharides, serving different functions including reinforcement and strength to the endoskeleton of e.g. plants and crustaceans [6, 7].

Wood-based cellulose pulp is the main resource for paper production. Chitin, which is rich in nitrogen, originates in the exoskeletons of marine crustaceans, shellfish, and insects as well as some fungi and microorganisms. The primary and secondary hydroxyl and amine functional groups in its molecular structure enable various chemical modifications for the desired applications. Deacetylation of chitin by alkaline treatment results in chitosan containing randomly distributed units of β-(1, 4)-linked D-glucosamine and N-acetyl-D-glucosamine. As a polycationic linear polysaccharide, chitosan has wide range of applications in e.g. agriculture, food, water treatment, biomedical, pharmaceutical industries [8-10].

Thus, polysaccharides from renewable agro-resources provide great potential to develop novel bio-based recyclable materials suitable for a variety of environmentally benign applications, hence reducing the dependency on fossil fuels and associated environmental concerns [11].

Likewise, there is a growing interest on phase change materials (PCMs) for their inherent temperature regulative and heat storage characteristics. Phase change phenomenon, for example from a solid to a liquid state and vice versa, involves a relatively significant amount of heat exchange with the surrounding environment resulting in temperature stabilization. PCMs can therefore absorb, store and release large quantities of heat (thermal energy), which make them suitable for temperature regulation (heating and cooling) and heat storage applications. Furthermore, as the temperature of charging and discharging heat to the PCMs remain constant, i.e. a constant temperature of fusion, PCM-based heat storage can benefit specific applications requiring constant working temperature.

For this, PCMs have be employed in a variety of applications including temperature responsive textiles, thermally active packaging, thermal protection in electronics, energy-positive buildings, air-conditioning, cooling, domestic hot water production, and solar heating system etc. [12-15].

However, the most critical limiting factors linked to the real-world use of PCMs are the useful life cycle of PCM-container systems, fluidity/leakage in the melt state, phase separation, poor thermal stability, undesired heat release, and corrosion between the PCM and the container that causes the necessary use of special devices, which in return will increase the associated cost. Thus, the application of PCMs usually requires a method to thermally and structurally stabilize their thermophysical properties, to prevent their fluidity as leakage in their melt phase and to control their volume change during the phase change process.

Shape-stabilization, encapsulation and confinement by support materials such as polymers, minerals, porous carbons and metals have been devised to overcome these issues linked to the applicability of PCMs. PCMs are commonly used, for example, in the form of capsules in the heat storage containers. The encapsulation material and PCMs need to be chemically and structurally compatible within the working temperature range without experiencing deformation and thermal degradation [14, 16-18].

U.S. Pat. No. 6,689,466 to Hartmann [19] introduces stabilized phase change compositions consisting of a PCM and a stabilizing agent such as antioxidants and thermal stabilizers. Hartmann discloses the application of their stabilized PCM composition in temperature regulative synthetic fibres, fabrics and textiles.

U.S. Pat. No. 6,183,855 to Buckley [20] introduces a flexible composite material comprising a PCM within a flexible matrix, with proposed applications in wearables for heating or cooling purposes.

European Pat. No. 1838802 B1 to Rolland and Reisdorf [21] relates to a material composition comprising a PCM (20-80 wt %) and one or more low polarity synthetic polymers (20-80 wt %) selected from for example very low density polyethylene, ethylene propylene rubber, and styrene copolymers. They disclose the PCM compositions for various thermal applications e.g. in constructions, automotive, packaging, and garments.

U.S. Pat. No. 5,916,477A to Kakiuchi et al. [22] discloses a heat storage/heat radiation method comprising a sugar alcohol heat storage material in an apparatus under an oxygen depleted atmosphere. They introduce the method as a preventive approach for oxidation of sugar alcohols duo to low thermal stability during repeated heating and cooling cycles which causes gradual decrease of fusion latent heat.

U.S. Pat. No. 5,785,885A to Kakiuchi et al. [23] discloses a heat storage material composition including one/more sugar alcohol e.g. erythritol, mannitol and galactitol, and a sparingly soluble salt. The role of the salt is explained as a supercooling inhibitor for a reproduceable crystallization.

U.S. Pat. No. 6,108,489A to Frohlich, Koellner and Salyer [24] discloses a heating device for food and other products, which include a unit containing a phase change material, which is capable of being charged with thermal energy.

After charging with heat, the PCM-incorporated device releases heat to keep foods and other objects warm. U.S. Pat. No. 5,370,814A to Salyer [25] discloses a powdered mixture of a PCM and silica particles. They disclose the usage of the mixture in different articles such as medical wraps, tree wraps, garments, blankets, and temperature sensitive articles e.g. aircraft flight recorders. US Pat No. 20020033247A1 to Neuschutz and Glausch [26] discloses usage of PCMs in heat sinks for electronics for thermal shock protection.

The advantages and the drawbacks of PCMs in practice are well-stablished knowledge. In order to be applicable, PCMs require one or more supporting elements to improve and/or to solve the linked issues or simply enhance and create new functionality. Considering the principles of sustainability and green chemistry, important inherent characteristics of materials such as renewable against finite, benign against hazardous, and biodegradable against non-degradable need to be addressed from the design stage with the raw materials to manufacturing and the final products [27].

While synthetic polymers have been vastly utilized as supporting materials for stabilization and encapsulation of PCMs, polysaccharides, natural/bio polymers originating from renewable sources have remained underused for this purpose. Due to the increasing environmental concerns, utilization of greener eco-friendly materials is getting increasingly essential, especially, for industries previously relaying on nondegradable polymers in their products and precursors. Synthetic petrochemical based polymers are less preferred compared to polysaccharides, which are derived from plants and/or microorganisms with intrinsic properties of biocompatibility, biodegradability and non-toxicity, especially in the eyes of environmentally conscious consumers [28].

U.S. Pat. No. 6,765,042 B1 to Thornton et al. [29] discloses a process for producing an acidic polysaccharide-based superabsorbent, comprising one/more polysaccharides with acidic functional groups, e.g. carboxymethyl cellulose and/or 6-carboxy starch, crosslinked by a crosslinking agent, to be used for odor control of malodorous fluids.

US Pat. No. 0023658 A1 to Stroumpoulis and Tezel [30] discloses tunably cross-linked biocompatible polysaccharide compositions, in particular, compositions of hyaluronic acid gels that are cross-linked with a multifunctional crosslinker, and the methods of making such cross-linked hyaluronic acid gels. There are several affecting factors on the functional properties of polysaccharide-based super-adsorbents, e.g. swelling and fluid retention capacity, include hydrophilicity, crosslinking density, and ionic strength [31].

However, covalent cross-linking agents pose the risk of toxicity and reduced swelling fluid retention properties [32]. On the contrary, ionic agent bridges between the polysaccharide macromolecule through reversible ionic bonds, resulting in easy reconfiguration and tunable physical properties and self-healing from physical damage, unlike chemical crosslinking through irreversible covalent bonds. Polysaccharides provide numerous non-covalent secondary interactions, mainly intra and inter-chain hydrogen bonding, defining their solubility in the surrounding environment. Ionic interactions, ion-binding and ion-complexation also play a key role in creating and modifying polysaccharide based materials [33].

For example, water molecules exist in different states of binding in the phase transition region surrounding a polysaccharide macromolecule: (i) strongly attached water that is incapable of phase transition, (ii) moderately attached water undergo phase transition and (iii) bulk and capillary water filling the pores in the fibrous structure [33, 34].

### SUMMARY OF THE INVENTION

It is an aim of the present invention to provide novel temperature responsive phase change bio-complexes (PCBC) with tunable thermophysical properties.

It is another aim of the present invention to provide a preparation method thereof.

The present phase change bio-complexes comprise a phase change material (PCM) (or mixture of PCMs) and a polysaccharide (or combination of polysaccharides).

The polysaccharide provides mechanical and thermal stabilization and the PCM provides temperature responsive properties to the complexation. In order to undergo complexation with polysaccharides, sugar alcohols and salt hydrates classifications of PCMs are preferred which results in compatibility and homogeneity of the bio-complexes.

In the method, complexes comprising PCMs are prepared in the presence of polysaccharides, thus forming a temperature responsive network or “bionetwork” entrapping the PCM due to their compatible intermolecular interactions, which results in thermal and structural stabilization.

The thermophysical properties of the bio-complexes may be tuned through molecular interactions and complexations such as ionic interaction by addition of mono- and/or multivalent cations and/or salts of an acid. Incorporation of di/multivalent cations, i.e. alkaline earth and transition metal ions, in the complexation may also provide added strength.

More specifically, the present invention is mainly characterized by what is stated in the independent claims.

Unlike previously reported polymers as stabilizing agent of PCMs, which often require petroleum-based hazardous monomers, polymerization reaction, covalent toxic crosslinkers, and hazardous explosive initiators with high-demanding safety precautions, the phase change bio-complexes of present invention are composed of bio-compatible and nontoxic feedstock such as polysaccharides from agro-recourses such as plant and bacteria and food-grade salts.

Compared to previously stabilized PCMs, the phase change bio-complexes provide high-heat storage capacity (latent heat charge and discharge) due to embedding high content of PCM. Solid-to-gel transition provides the bio-complexes with structural-stability and leakage-preventive properties of the PCM in the melt state owing to the stabilizing and gel-forming properties of the polysaccharide.

The phase change bio-complexes may be used repeatedly in the view of thermal and mechanical stability. The phase change complexes may be prepared through simple blending in water and/or water-miscible solvents. The phase change bio-complexes may be processed through different methods such as casting, spinning, additive manufacturing, freeze-drying and moulding, to prepare articles in different forms e.g. films, pellets, sheets, beads, sponges, filaments, papers etc. providing tunable temperature-reversible properties.

The phase change bio-complexes can be used in highly concentrated liquid and/or gel forms as well as fully dehydrated forms. The phase change bio-complexes can be applied for thermal management purposes e.g. heat storage and thermal protection via heat absorbing-releasing, for instance in building, packaging, electronics, temperature sensitive items (black boxes), tree wraps and wearables.

The preparation and processing are entirely aqueous and with environmentally benign feedstock resulting in efficient sustainable production of the bio-complexes. The method is conducted in the presence of an ionic agent, for example, but not limited to, salts of an acid such as citric acid and/or di/multivalent cations such as calcium, magnesium, iron etc. acting as chelating/complexation agent for tuning the thermophysical properties of the compositions including structural-stability and the phase change temperatures and latent heat of fusion.

The presence of alkali metal ions e.g. sodium increases the reactivity and swelling properties of polysaccharides in the bio-complexes so that it can be loaded with high content of PCM. The alkaline earth and/or transition metal ions act as chelating agent bridging between different chains of polysaccharides and ligands for PCM molecules. The bio-complexes provide highly repeatable and tunable thermophysical properties including glass transition, solidification and melting temperatures and fusion enthalpy and structural stabilization.

Addition of multivalent cations, such as alkaline earth metal ions, may also provide additional mechanical strength to the bio-complexes. Due to the miscibility of the incorporated compounds, the complexes show homogeneous structure in both solid and melt states of the phase change compound. The phase change bio-complexes can be easily processed in different structurally stable articles for example, but not limited to, powder, granules, beads, sheets, films etc. and applied for thermal management purposes in thermal energy storage and protection via latent heat of fusion. The design, preparation, processing and final bioproducts disclosed in present invention fulfil both the function and the principles of sustainability and green chemistry such as renewability, nontoxicity, and biodegradability.

The current invention discloses that natural polysaccharides in various available forms, including powder, fibres, and particulates, enable thermal and structural stabilization of PCMs, preferably from sugar alcohols and salt hydrates categories, due to providing high miscibility and molecular-level interactions.

The mechanism of stabilization would seem to rely on complexation of polysaccharides with the smaller molecules of the PCMs which is assisted by the presence of an ionic agent such as salt of an acid, e.g. sodium citrate, sodium tripolyphosphate, and/or di/multivalent cations e.g. calcium, magnesium, and other metal ions.

The thermal properties of the developed bio-complexes can be tuned by adding the ionic agents. The disclosed bio-complexes may be applied for sustainable and stabilized thermal management applications including heat storage and thermal protection.

The novel bio-products of the present invention provide added benefits and open new applications for the complexes of polysaccharides and phase change materials in thermal energy storage and conservation, thermal protection of electronics and temperature sensitive items e.g. black boxes and in a broader view cosmetics, textiles, packaging and other environmentally friendly applications.

### BRIEF DESCRIPTION OF THE DRAWINGS

FIG. 1 presents schematic of molecular complexation and structuring of a thermally responsive phase change bio-complexes with tunable thermal and mechanical properties and high heat storage capacities.

FIG. 2 presents schematic of complexation and shape stabilization of thermally responsive phase change bio-complexes by using calcium-ion cross-linked alginate polysaccharide.

FIG. 3 presents a schematic representation of possible stabilization states (A, B, C) for the phase change molecules surrounding polysaccharide in the phase change bio-complexes. A fraction is strongly attached to the polysaccharide macromolecule leading superstability and non-phase change properties. B fraction is moderately involved and stabilized phase change molecules. C fraction includes uninvolved phase change molecules.

FIG. 4 presents scanning electron microscopy of erythritol crystals complexed with polysaccharides (25 wt %) under 100 and 10 μm scale bar; (a) complexation with chitin and (b) complexation with pulp.

FIG. 5 presents structural stabilization of erythritol through complexation with polysaccharides (25 wt %) under 3 hours heat exposure at 130° C. It is observed that pure erythritol is in liquid form, whereas, erythritol complexed with polysaccharide is form-stable above melting point.

FIG. 6 presents (a) Differential scanning calorimetry (DSC) curves of erythritol (ERY) complexed with 25, 20, and 10 percentages (wt %) of alginate (ALG) (without addition of ionic agent (IA)). (b) DSC curves of ERY complexed with 25 percentage of ALG in the presence of IA (calcium ion). (c) Repeatability of phase change properties of ERY complexed with 23.5 percentage of ALG (1.5% calcium ionic crosslinked) under 100 DSC heating-cooling cycles.

FIG. 7 presents (a) Differential scanning calorimetry (DSC) curves of erythritol (ERY) complexed with 25, 20 and 15 percentage (wt %) of xanthan gum (XAN) in the absence of ionic agent (IA). (b) DSC curves of 75% of ERY complexed with XAN in the presence of citrate ionic agent.

FIG. 8 presents (a) Differential scanning calorimetry (DSC) curves of erythritol (ERY) complexed with 20, 17.6, and 13.2 percentages (wt %) of chitosan (CTS) in the presence of citrate ionic agent (IA). (b) Repeatability of phase change properties of ERY complexed with 17.6 percentage of CTS (ionic citrate cross-linked) under 100 DSC cycles.

FIG. 9 presents (a) Differential scanning calorimetry (DSC) curves of sugar alcohol (erythritol (ERY) and mixture of ERY and mannitol (MAN) (mixture=70% ERY and 30% MAN) complexed with different percentage (wt %) of guar in presence and absence of ionic agent (IA). (b) DSC curves of ERY complexed with 20 percentage of starch (STC) in the presence of ionic agent (citrate ion).

FIG. 10 presents (a) Differential scanning calorimetry (DSC) curves of erythritol (ERY) complexed with pulp (wood-cellulose fibers) in the presence of citric acid. (b) Repeatability of phase change properties of ERY complexed with 14 percentage of cellulose pulp (14% citric acid cross-linked) under 100 DSC heating-cooling cycles. (c) DSC curve of polyethylene glycol (PEG, MW 1000) complexed with pulp and citric acid.

FIG. 11 presents (a) Differential scanning calorimetry (DSC) curves of erythritol (ERY) complexed with chitin (CTN) particles in the presence of ionic agent (citrate and calcium ion) (wt %). (b) Repeatability of phase change properties of ERY complexed with 24 percentage of chitin (6% citric-calcium cross-linked) under 100 DSC heating-cooling cycles.

### DETAILED DESCRIPTION OF EMBODIMENTS

As used herein, the term “average molecular weight” refers to a weight average molecular weight (also abbreviated “Mw” or “Mw”).

Unless otherwise indicated, the molecular weight has been measured by gel-permeation chromatography using polystyrene standards.

As used herein, the complexes provided are also referred to as “bio-complexes” to denote that at least some of the components thereof are biocompatible or of non-synthetic origin. Examples of such components are polysaccharides.

As will appear, in embodiments, the present phase-change complexes or “bio-complexes” are typically composed of bio-compatible and nontoxic feedstock, such polysaccharides from agro-recourses such as plant and bacteria and food-grade salts.

Unless otherwise stated herein or clear from the context, any percentages referred to herein are expressed as percent by weight based on a total weight of the respective composition.

The phase change bio-complexes comprise, consist of, or consist essentially of a phase change material (PCM) (or mixture of PCMs) and a polysaccharide (or combination of polysaccharides). The polysaccharide provides mechanical and thermal stabilization and the PCM provides temperature responsive properties to the complexation.

In order to undergo complexation with polysaccharides, sugar alcohols and salt hydrates classifications of PCMs are preferred which results in compatibility and homogeneity of the bio-complexes. Addition of multivalent cations (for example in the form of water soluble salts) and/or salts of an acid tunes the thermophysical properties of the bio-complexes, such as tunable temperature and latent heat of fusion and structural and thermal stability.

In embodiments of the present technology, polysaccharides are introduced as sustainable and biocompatible support matrices for the PCMs, which both improve and stabilize the structural properties as stabilization of form and prevention of leakage and/or phase separation and enhance and tune the thermal properties.

In embodiments, biocompatible complexes of polysaccharides and derivatives with bio-based phase change materials are introduced in order to tune the thermophysical characteristics, in particular, the phase change and structural properties.

As a result, ionically cross-linked or complexed bio-complexes are provided.

The bio-products of the present embodiments have the advantages of tunable thermal properties such as glass transition and phase change temperature and corresponding latent heat. Prepared through a simple water-based fabrication method, disclosed bio-complexes perform more effectively and stably in both thermal and structural properties than the pristine phase change materials.

Analogous to the compositions of polysaccharides previously disclosed as water super-adsorbents, polysaccharides show high potential as superabsorbent of PCMs for thermal and structural stabilization purposes in thermal management applications.

Embodiments generally relate to compositions of and phase change material (PCM) complexed with polysaccharide, methods of preparing and tuning the thermophysical properties with the aid of an ionic agent such as salt of an acid and/or di/multivalent cations, and method of using such compositions.

Elements involved in the bio-complexation include polysaccharide as mechanical and thermal stabilizer, PCM as the thermal energy storage, and ionic agent as the tuner of thermophysical properties.

The phase change bio-complexes can be charged with large amounts of latent thermal energy at a constant temperature of fusion without leaking of the PCM due to fluid retention properties of the polysaccharide and the stored heat can be released by crystallization at tunable temperature through ionic agent.

Various polysaccharides may be utilized as feedstock in embodiment of the present invention including structural polysaccharides, such as cellulose pulp and chitin particulate, as well as storage and bacterial polysaccharides for example, but not limited to, starch, guar gum, xanthan gum, and alginic acid along with other derivatives such as ionic and/or non-ionic derivatives including chitosan and carboxymethyl cellulose.

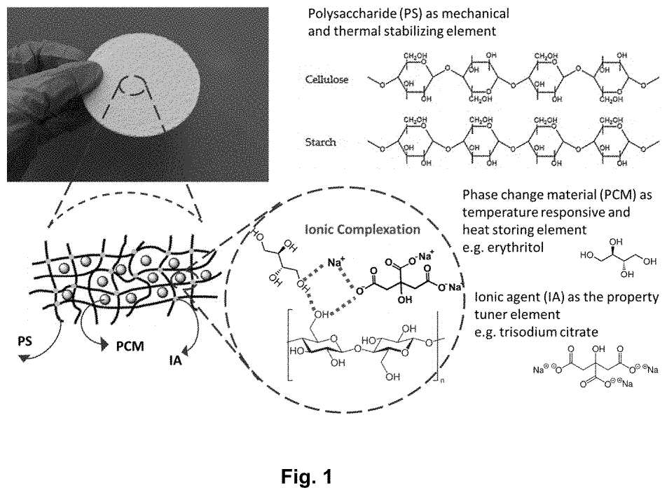

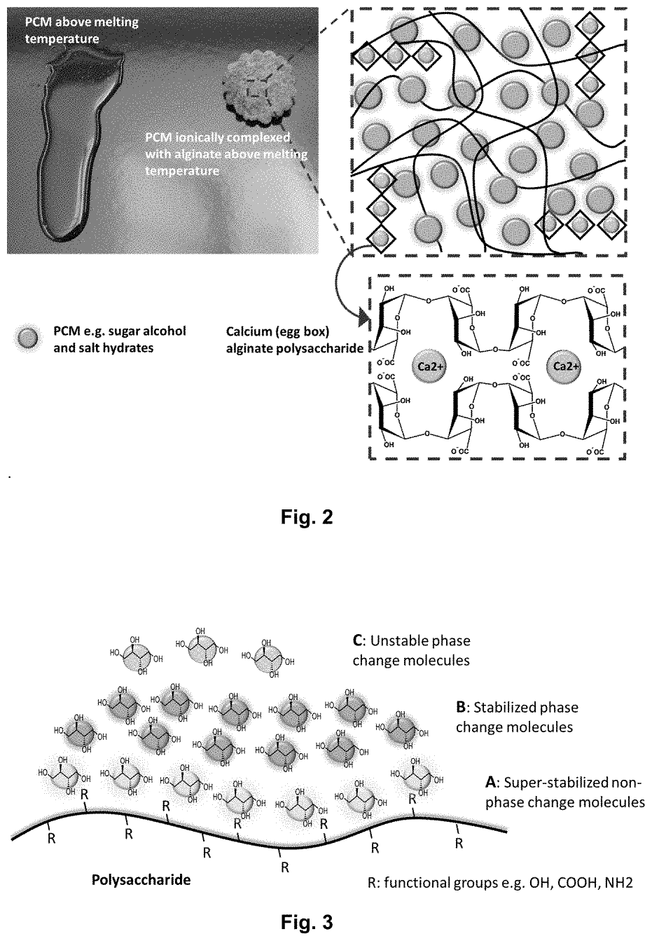

Numerous secondary non-covalent interactions are related to the miscibility of PCMs within the polysaccharide bionetwork. Along with intra and inter-chain hydrogen bonding, ionic interactions and ion-chelating play a key role in creating the complexation and stabilization of phase change molecules, as illustrated schematically in FIG. 1 and FIG. 2.

FIG. 1 shows molecular complexation and structuring of a thermally responsive phase change bio-complexes with tunable thermophysical properties and high heat storage capacities.

FIG. 2 shows complexation and shape stabilization of thermally responsive phase change bio-complexes with calcium-ion cross-linked alginate polysaccharide with tunable thermophysical properties.

The functional groups including carboxyl, hydroxyl and amine on the molecular structure of polysaccharides enable ion exchange, for instance, with multivalent cations e.g. metal ions including alkaline earth and transition metals such as calcium, magnesium, iron or cupper cations. Ion containing polysaccharides provide higher stabilization through providing more ligands for complexation with phase change molecules.

In embodiments, the presence of alkali ions, such as sodium and potassium, increases the reactivity and swelling properties of polysaccharides leading to higher stabilization. As different ions can have different level of influence on the swelling and fluid retention properties of polysaccharides, suitable ionic agents include salts of an acid such as, for example, but not limited to, acetic acid and oxalic acid and/or multivalent cations such as calcium, magnesium, and other alkaline earth and transition metal ions. Both ions involved in the salt may affect the polysaccharide complexation ability with the PCMs.

In order to undergo complexation with polysaccharides, sugar alcohol and salt hydrate classifications of PCMs are preferred.

The existence of phase change substances with suitable functional groups, for example hydroxyl groups on the molecular structure of sugar alcohols, in the system increases the potential of the ionic agents. The involvement of all ionic compounds and hydroxyl groups of phase change molecules undergo complexation with functional groups on the polysaccharide chains resulting in physical stabilization. Furthermore, the smaller molecular size molecules of phase change materials can penetrate the swollen fibrous structure of structural polysaccharides, e.g. cellulose and chitin, so that pore filling and capillary forces also contribute in stabilization process.

FIG. 3 schematically illustrates possible stabilization states for the phase change bio-complexes of present invention including super-stable non-phase change and moderately stabilized phase change molecules.

More specifically, FIG. 3 gives a schematic representation of possible stabilization states (A, B, C) for the phase change molecules surrounding polysaccharide in the phase change bio-complexes. A fraction is strongly attached to the polysaccharide macromolecule leading superstability and non-phase change properties. B fraction is moderately involved and stabilized phase change molecules. C fraction includes uninvolved phase change molecules.

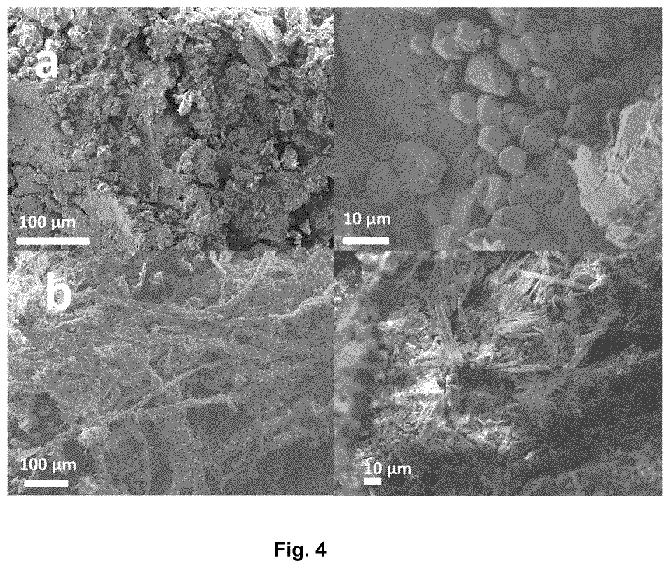

FIG. 4 shows scanning electron microscopic images of the stabilized crystals complexes with pulp and chitin polysaccharides. The results will be discussed in connection with Example 1.

In embodiments of the present technology, the phase change polysaccharide-based bio-complexes are classified as a class of soft materials with tunable thermophysical properties.

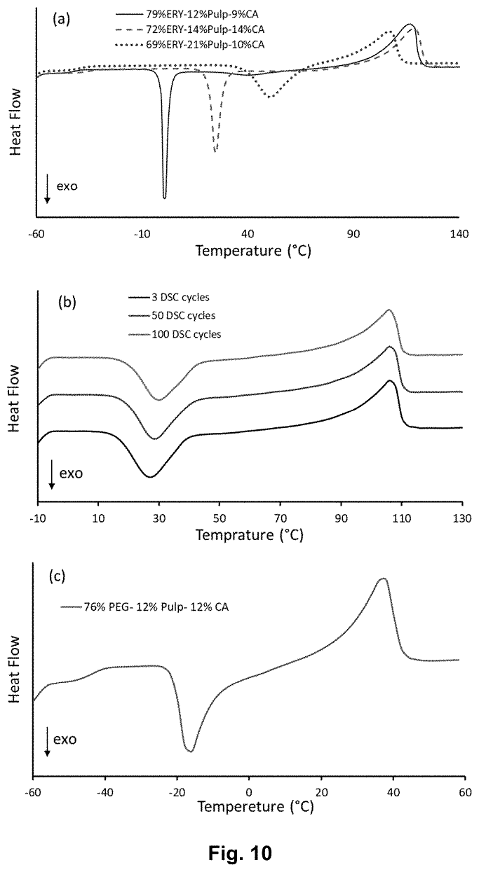

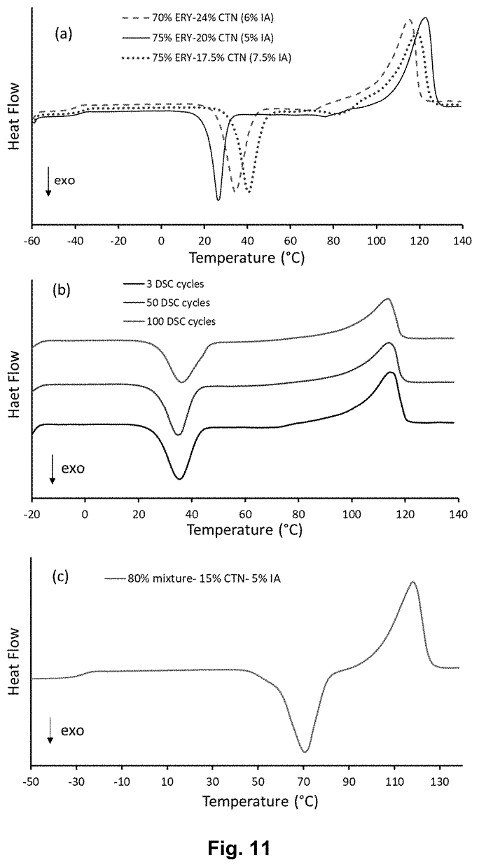

The structural stabilization results in leakage-preventive properties of ionic complexes of PCMs by polysaccharides (FIG. 10) due to numerous intermolecular interactions i.e. fluid retention by polysaccharides towards PCM molecules.

In embodiments, the polysaccharides undergo swelling in the melted PCM and hold a large amount of PCM while preserving the physical structure. Since the bio-complexes are ionically cross-linked (noncovalent cross-linking), easy dissociation and formation of new secondary bonds can restructure the physical network. Reversibility of these interactions, in return, leads to tunable physical properties, such as resiliency to mechanical damage, which can improve the life cycle of the phase change bio-complexes under repeated heating-cooling cycles.

Analogous to the swelling of polysaccharides during hydration, three different states of stabilization exist for the phase change molecules within the polysaccharide bio-complexation. As presented schematically in FIG. 3, a few layers of phase change molecules adjacent to the polysaccharide chains have stronger intermolecular interactions, e.g. ionic ligands, with the macromolecules. The stronger the interactions, the stronger the hold which leads to super-stabilization and non-phase change behavior of this fraction of phase change molecules (A fraction in FIG. 3).

The second state is the phase change molecules yet stabilized due to milder intermolecular interactions with polysaccharides, e.g. hydrogen bonding and Van der Waals forces (B fraction in FIG. 3). The stabilized phase change molecules are supposed to show some extend of depression for melting temperature. The phase change molecules, which are not involved in the complexation with the polysaccharide, will behave as the bulk PCM, e.g. leak as fluid from the bio-complex (C fraction in FIG. 3).

In embodiments, the existence of unstable phase change molecules is prevented and controlled by the weight percentage and adsorptive strength of the polysaccharide in the complexation as well as the addition of ionic agent.

Ionic agents significantly affect the stabilized and super-stabilized fractions of the PCM in the complexes. Alkali salts increase the reactivity and swelling of polysaccharides, resulting higher availability of active adsorptive sites on the macromolecule chains for attractive interactions with phase change molecules. The alkaline metal and transition metal ions such as calcium, magnesium, iron, and cupper act as chelating ligands for the complexation between the macromolecule chains as well as phase change molecules. In other words, incorporation of ionic agent result in stronger involvement of PCM and polysaccharides and consequently higher stabilization. In the case of structural polysaccharides such as chitin fibrillous particulates and pulp, the presence of ionic agents for activation of active sites to undergo complexation may be necessary.

The thermal properties, including glass-transition, crystallization and melting, of the disclosed phase change bio-complexes can be tuned by the amount of the polysaccharides and the presence of the ionic agents.

In a first embodiment, the phase-change bio-complexes consist of a phase change material (PCM) (or mixture of PCMs) and a polysaccharide (or combination of polysaccharides).

In a second embodiment, the phase-change bio-complexes consist of a phase change material (PCM) (or mixture of PCMs), a polysaccharide (or combination of polysaccharides), and cations.

In a third embodiment, the phase-change bio-complexes consist of a phase change material (PCM) (or mixture of PCMs), a polysaccharide (or combination of polysaccharides), Table 1 gives a compilation of the phase change properties of some examples of bio-complexes with varying compositions of polysaccharide, PCM and ionic agent, including the temperatures of glass-transition (Tg), crystallization (Tc), and melting (Tm) and the corresponding latent heat of charring and discharging.

TABLE 1
Tunable thermal properties of erythritol PCM complexed with polysaccharides
in the presence of ionic agent; T_{g} glass transition temperature, T_{c} crystallization temperature,
Tₘ melting temperature, ΔH_{c} crystallization latent heat and ΔHₘ melting
latent heat. Rest of the composition wt % is the PCM.

| | composition | ionic agent | T_{g} | Tₛ | ΔH_{c} | Tₘ | ΔHₘ |
|---|---|---|---|---|---|---|---|
| Polysaccharide | (wt %) | (wt %) | (° C.) | (° C.) | (J/g) | (° C.) | (J/g) |
| Starch | 20 | 0 | −34.8 | 5.4 | −104.4 | 112.8 | 237.7 |
| Starch | 18.6 | 2.4 | −34.0 | 11.1 | −135.4 | 111.3 | 276.1 |
| Starch | 15.2 | 4.8 | −32.4 | 21.4 | −141.2 | 110.6 | 262.1 |
| Alginic acid | 25 | 0 | −26.0 | 31.1 | −127.0 | 105.2 | 182.8 |
| Alginic acid | 23.5 | 1.5 | −29.2 | 33.1 | −149.0 | 100.6 | 187.5 |
| Alginic acid | 23 | 2 | −27.3 | 33.3 | −154.0 | 101.6 | 199.9 |
| Xanthan gum | 25 | 0 | −29.9 | 7.9 | −122.0 | 108.3 | 195.4 |
| Xanthan gum | 22 | 3 | −28.3 | 30.2 | −132.3 | 106.6 | 203.5 |
| Xanthan gum | 19.75 | 6.25 | −27.0 | 33.9 | 150.5 | 105.0 | 211.4 |
| Chitosan | 13.2 | 1.8 | −35.5 | −0.9 | −134.8 | 113.9 | 263.9 |
| Chitosan | 17.6 | 2.4 | −35.5 | 2.5 | −110.6 | 111.0 | 224.0 |
| Chitosan | 20 | 5 | −32.8 | 13.1 | −110.5 | 109.6 | 195.2 |
| Chitin particle | 17.5 | 7.5 | −32.9 | 33.5 | −132.8 | 108.1 | 211.4 |
| Chitin particle | 20 | 5 | −34.8 | 21.2 | −99.26 | 109.7 | 224.0 |
| Chitin particle | 24 | 6 | −36.6 | 26.2 | −146.1 | 103.6 | 227.7 |
| Pulp (cellulose fiber) | 12 | 9 | −38.7 | −0.5 | −111.2 | 100.2 | 218.0 |
| Pulp (cellulose fiber) | 14 | 14 | −35.1 | 39.4 | −125.5 | 94.1 | 160.0 |
| Pulp (cellulose fiber) | 21 | 10 | −30.7 | 21.5 | −116 | 102.0 | 178 |

As will appear, in embodiments, the phase-change complexes comprise generally about 1 to 50%, for example 5 to 40%, in particular 10 to 35% by weight of the total weight of the complex of a polysaccharide, and up to 25%, for example 1 to 20%, or 1 to 15% by weight of the total weight of the complex of an ionic agent.

The phase change bio-complexes may be prepared from a base polysaccharide (or mixture of polysaccharides). In order to form complexation with polysaccharides, PCMs from sugar-alcohols, for example, but not limited to, erythritol, dulcitol, mannitol, glycerol, sorbitol, xylitol etc. and/or their mixture, and salt hydrates e.g. sodium acetate trihydrate, sodium carbonate decahydrate etc. may be preferred. To tune the thermal properties and improve structural complexation and physical gelation, an ionic agent for example, but not limited to, the salt of an acid, e.g. sodium citrate, sodium tripolyphosphate, and/or di/multivalent cations from alkaline earth and transition metal ions such as calcium, magnesium, iron, zinc etc. may be used in the embodiment of present invention. High loading of the PCM with highly repeatable phase change properties may be achieved due to the compatible nature as well as spontaneous and reversible interactions of incorporated components.

The following non-limiting examples disclose further details of embodiments of the present invention:

### Example 1

One embodiment of a phase change bio-complexes according to this invention may be prepared via a simple aqueous fabrication method by using bacterial polyanionic polysaccharides, e.g. alginic acid and xanthan, as follows:

A known amount of polyanionic polysaccharides, e.g. sodium alginate and xanthan gum, is dissolved in water at elevated temperature e.g. 50° C. until a homogenous hydrogel is obtained. PCM dissolved in water is added to the hydrogel under vigorous mixing. The PCM-polysaccharide system may be ionically cross-linked through in-situ addition of calcium ions, i.e. powdered CaCO₃ and glucono-δ-lactone are dispersed in the PCM-alginate solution or by addition of water soluble metal salts and/or salts of an acid, e.g. sodium citrate. The phase change bio-complexes may be processed in the form of beads, films, granules etc. by casting, moulding, additive manufacturing etc. and dried to be used for thermal energy managements. Due to compatible nature of the polysaccharide and the PCM (both water loving) high loading of PCM (up to 95 wt %) is achievable for desired stabilized thermal and structural properties.

FIG. 2 is a schematic depiction of the complexation mechanism, which leads to structural stabilization of alginate complexed PCM.

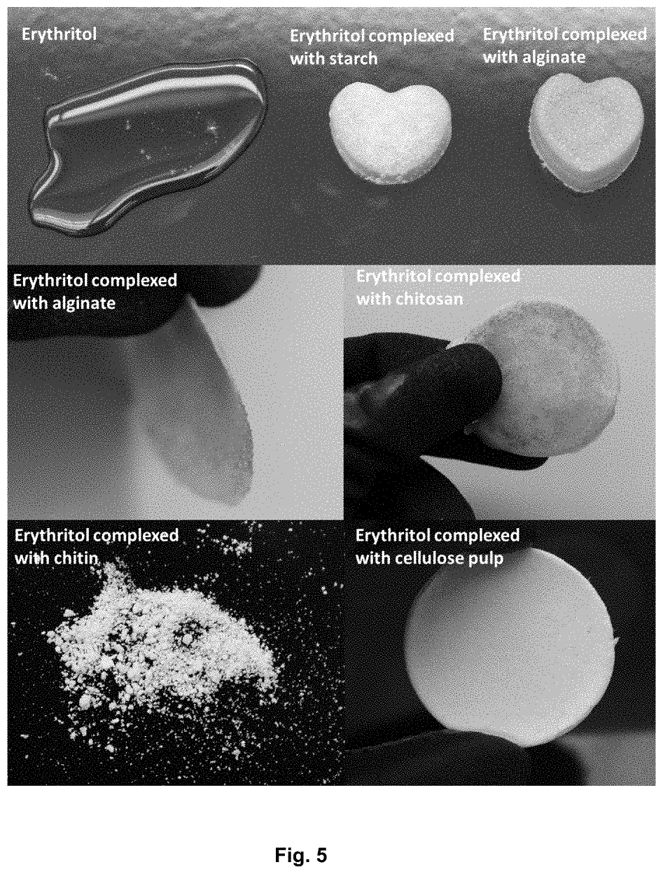

Different samples of the phase change bio-complexes of sugar alcohol and alginate and xanthan were prepared and characterized by differential scanning calorimetry (DSC). FIG. 4 and FIG. 5 depict the highly repeatable thermal properties, i.e. glass transition and phase change, of sugar alcohol PCM complexed with polyanionic polysaccharides. The thermal properties are tuned by the polysaccharide content and presence of ionic agent.

FIG. 4 shows the results of scanning electron microscopy of erythritol crystals complexed with polysaccharides (25 wt %) under 100 and 10 μm scale bar, indicating (a) complexation with chitin and (b) complexation with pulp.

FIG. 5 comprises photographs indicating structural stabilization of erythritol through complexation with polysaccharides (25 wt %) under 3 hours heat exposure at above melting temperature. As evident, pure erythritol in liquid form causes leakages, whereas, erythritol complexed with polysaccharide is form stabilized above melting point providing leakage prevention.

Table 1 compiles the related values for thermal properties of erythritol complexed with the polysaccharide in the absence and presence of ionic agent including glass transition temperature, crystallization temperature, melting temperature, and the corresponding latent heat of fusion. FIG. 5 illustrates structural stabilization of the complexed PCM by alginate in film and pellet forms.

### Example 2

A phase change bio-complexes according to this invention may be prepared by using a polysaccharide derivative, e.g. chitosan and carboxymethyl cellulose, via following method:

A predetermined amount of chitosan is dissolved in dilute aqueous acidic solution, e.g. 0.1 M acetic acid, at e.g. 50° C. until a homogenous gel is obtained. A predetermined amount of PCM dissolved in water is added to the gel under contentious mixing. An ionic agent for example, but not limited to, sodium citrate salt and/or di/multivalent cations e.g. Zn, Fe, Cu or Ni are added to in the PCM-chitosan solution. The final bio-product is produced via dehydration and melted prior to the use.

Several compositions of the phase change bio-complexes, e.g. erythritol and mixture of sugar alcohols, by chitosan were prepared and characterized by differential scanning calorimetry (DSC). FIG. 5 depicts highly repeatable thermal properties, i.e. glass and phase transition, of sugar alcohol PCM complexed with chitosan and sodium citrate. As observed the thermal properties are tuned by the ratio of the PCM and polysaccharide and the presence of ionic agent. Table 1 compiles tunable values of thermal properties of erythritol complexed with chitosan in the absence and presence of ionic agent. FIG. 5 illustrates structural stabilization of the complexed PCM by chitosan as a film.

### Example 3

A phase change bio-complexes according to an embodiment is prepared by using non-ionic polysaccharide, for example, but not limited to, starch and guar gum, via the following method:

A predetermined amount of the non-ionic polysaccharide is dissolved in water at elevated temperature, e.g. 50° C., until a homogenous gel is obtained. A predetermined amount of PCM, preferably dissolved in water, is added to the hydrogel while carefully mixing. In the case of non-ionic polysaccharide, addition of an ionic agent is necessary for stabilization. An ionic agent as exemplified by, but not limited to, sodium citrate salt and/or water-soluble metal salts, di/multivalent cations e.g. calcium, are added to the solution in order to tune the thermal properties. The final bio-product is produced via dehydration and melted prior to use.

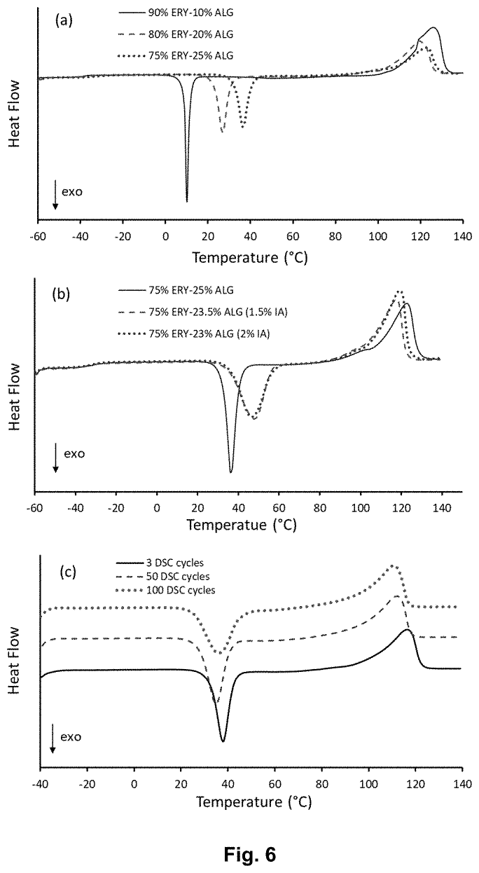

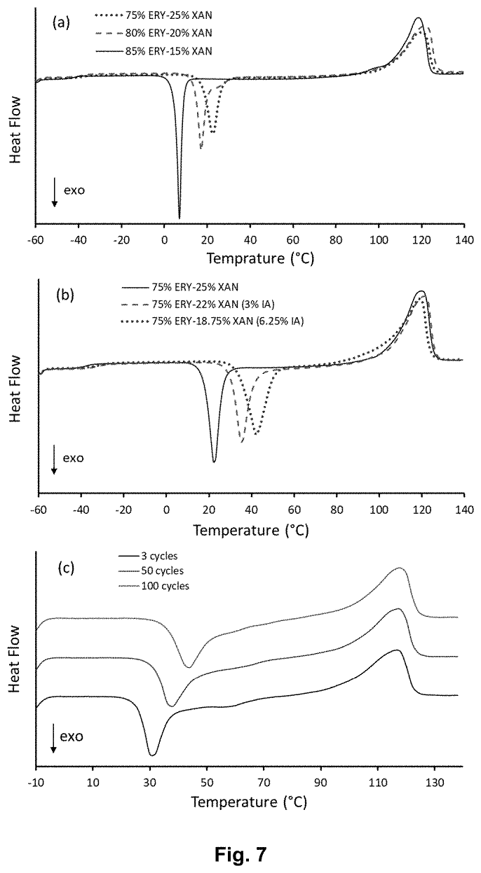

Several compositions of the phase change bio-complexes sugar alcohols by starch and guar were prepared and characterized by differential scanning calorimetry (DSC). FIGS. 6 and 7 presents repeatability of the thermal properties, i.e. glass and phase transition, of the bio-complexes. The thermal properties are mainly tuned by the presence of ionic agent. Table 1 further compiles the corresponding values for the thermal properties of the bio-complexes. The structural stabilization of the complexed PCM by starch is demonstrated in FIG. 5.

FIG. 6 (a) shows differential scanning calorimetry (DSC) curves of erythritol (ERY) complexed with 25, 20, and 10 percentages (wt %) of alginate (ALG) (without addition of ionic agent (IA)). FIG. 6 (b) shows DSC curves of ERY complexed with 25 percentage of ALG in the presence of IA (calcium ion). FIG. 6 (c) indicates the repeatability of phase change properties of ERY complexed with 23.5 percentage of ALG (1.5% calcium ionic crosslinked) under 100 DSC heating-cooling cycles.

FIG. 7 (a) shows differential scanning calorimetry (DSC) curves of erythritol (ERY) complexed with 25, 20 and 15 percentage (wt %) of xanthan gum (XAN) in the absence of ionic agent (IA). FIG. 7 (b) shows DSC curves of 75% of ERY complexed with XAN in the presence of citrate ionic agent. FIG. 7 (c) indicates the repeatability of phase change properties of ERY complexed XAN (ionic citrate cross-linked) under 100 DSC heating-cooling cycles.

### Example 4

A phase change bio-complexes of the present invention embodiments may be prepared by using structural polysaccharide, for example, but not limited to, cellulose pulp and chitin particulate, via the following method:

A predetermined amount of the structural polysaccharide (e.g. pulp and chitin) is dispersed in water at elevated temperature e.g. 80° C. while vigorously mixing until a homogenously dispersion is obtained. A predetermined amount of PCM, preferably dissolved in water is added to the dispersion under mixing. An ionic agent, for example, but not limited to, citric acid together with water soluble metal salts, e.g. calcium chloride, is added to the suspension. Complexation can further proceed with the addition of di/multivalent cations such as Fe and Cu for added strength. In the case of structural polysaccharide addition of ionic agent is necessary for stabilization. The final step is dehydration via different processing methods casting, moulding etc.

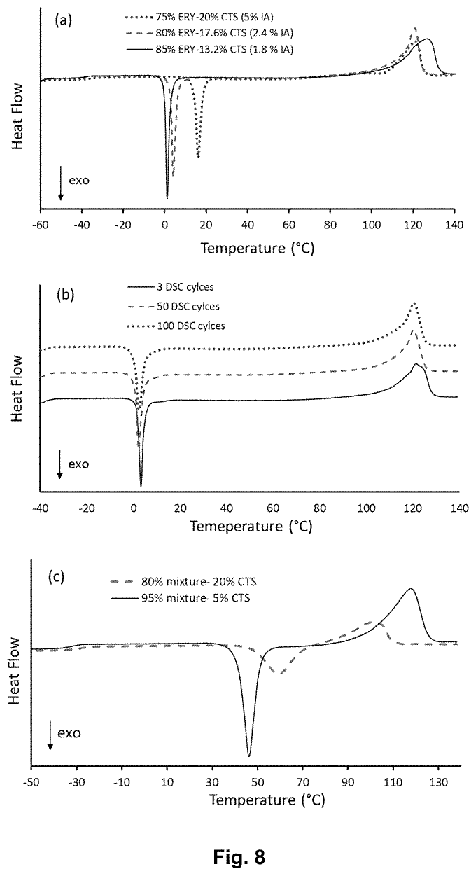

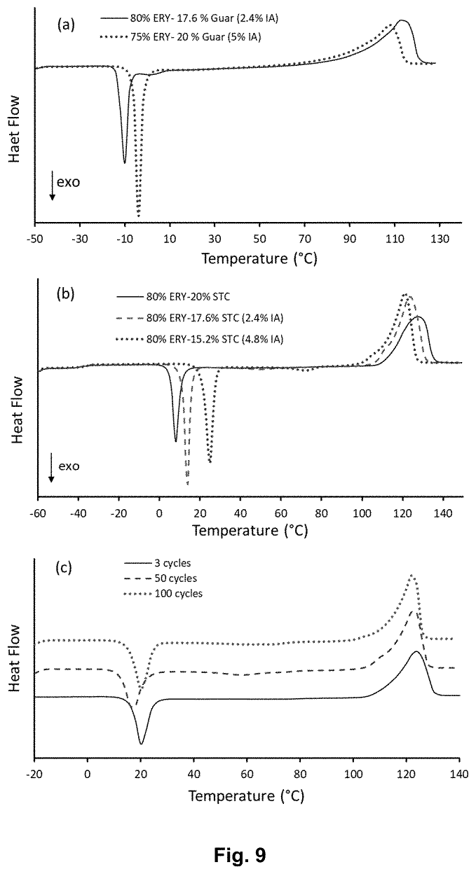

Several compositions of the phase change bio-complexes sugar alcohols by pulp and chitin were prepared and characterized by differential scanning calorimetry (DSC). FIG. 8 and FIG. 9 presents repeatability of the tunable thermal properties, i.e. glass and phase transition, of the bio-complexes.

FIG. 8 (a) shows differential scanning calorimetry (DSC) curves of erythritol (ERY) complexed with 20, 17.6, and 13.2 percentages (wt %) of chitosan (CTS) in the presence of citrate ionic agent (IA). FIG. 8 (b) indicates the repeatability of phase change properties of ERY complexed with 17.6 percentage of CTS (ionic citrate cross-linked) under 100 DSC cycles. FIG. 8 (c) shows DSC curves of sugar alcohol mixture (70% ERY and 30% mannitol) complexed with chitosan.

FIG. 9 (a) shows differential scanning calorimetry (DSC) curves of sugar alcohol (erythritol (ERY) complexed with different percentage (wt %) of guar in the presence of ionic agent (IA). FIG. 9 (b) shows DSC curves of ERY complexed with 20 percentage of starch (STC) in the presence of ionic agent (citrate ion). FIG. 9 (c) indicates the repeatability of phase change properties of ERY complexed with STC (ionic citrate cross-linked) under 100 DSC cycles.

The thermal properties are tuned mainly by the ionic agent. Table 1 above gives a compilation of the corresponding values for the thermal properties of the bio-complexes.

The structural stabilization of the complexed PCM by pulp and chitin in pellet and powdered forms is demonstrated in FIG. 5. FIG. 10 (a) shows differential scanning calorimetry (DSC) curves of erythritol (ERY) complexed with pulp (wood-cellulose fibers) in the presence of citric acid. FIG. 10 (b) depicts the repeatability of phase change properties of ERY complexed with 14 percentage of cellulose pulp (14% citric acid cross-linked) under 100 DSC heating-cooling cycles. FIG. 10 (c) is a DSC curve of polyethylene glycol (PEG, Mw 1000) complexed with pulp and citric acid.

FIG. 11 shows the scanning electron microscopic images of complexed crystals of PCM on the surface of pup and chitin particles. FIG. 11 (a) depicts differential scanning calorimetry (DSC) curves of erythritol (ERY) complexed with chitin (CTN) particles in the presence of ionic agent (citrate and calcium ion) (wt %). FIG. 11 (b) depicts the repeatability of phase change properties of ERY complexed with 24 percentage of chitin (6% citric-calcium cross-linked) under 100 DSC heating-cooling cycles. FIG. 11 (c) gives DSC curves of sugar alcohol mixture (70% ERY and 30% mannitol) complexed with chitin in the presence of ionic agent.

### Example 5

An embodiment includes ionically complexed polyethylene glycol PCM with polysaccharides. As both components are highly missile in water, the preparation is simple, and water based. To ensure complexation citric acid together with a di/multivalent cation such as alkane earth metals such as calcium and/or transition metals e.g. Fe, Cu are necessary.

The preparation is preferably conducted at an elevated temperature of, e.g., 80° C. In order to undergo complexation with polysaccharides, lower molecular weight (Mw) polyethylene glycol for example, but not limited to, Mw 600-4000 are preferred.

FIG. 10 presents the thermal properties, i.e. glass and phase transitions, of the polyethylene glycol (Mw 1000) complexed with cellulose pulp through the aid of citric acid.

### Example 6

An embodiment of the present invention includes fatty acids by example, but not limited to myristic acid, lauric acid and decanoic as PCMs to be ionically complexed with polysaccharides. In the case of fatty acids, suitable solvents for preparation includes weakly polar organic solvents, such as ethanol. To avoid precipitation of the PCM during preparation and processing, the ratio of water for dissolving polysaccharide and the solvent for the PCM is typically adjusted to e.g. 1/1 or 2/1 wt %. The preparation is preferably conducted at elevated temperature selected in accordance to the fusion temperature of the PCM for complexation, preferably lower. In order to undergo complexation with polysaccharides, the number of carbons in the fatty chain is preferred to be smaller.

As will be understood from the preceding description of the present invention and the illustrative experimental examples, the present invention can be described by reference to the following embodiments:
1. Sustainable phase change bio-complexes characterized by tunable thermophysical properties.
   a) the phase change bio-complexes of embodiment 1 wherein the polysaccharide is derived from microorganisms such as alginic acid and xanthan gum.
   b) the phase change bio-complexes of embodiment 1 wherein the complexed phase change material (PCM) with the polysaccharide is from a sugar alcohol or a mixture of sugar alcohols.
   c) the phase change bio-complexes of embodiment 1 wherein the thermal properties are tuned by addition di/multivalent cations including alkaline earth metals such as Ca, Mg and transition metals such as Fe, Zn, Al etc. and/or salts an acid such as citric acid e.g. sodium citrate, sodium tripolyphosphate etc.
   d) the phase change bio-complexes of embodiment 1 wherein the PCM with the polysaccharide is from salt hydrates.
2. A simple green aqueous-based preparation method of the phase change bio-complexes of embodiment 1, which the method comprises:
   dissolving the polysaccharide in water heated above e.g. 50° C. while mixing to obtain a homogeneous solution wherein the PCM and salt of an acid e.g. sodium citrate and/or water soluble di/multivalent metal salts are added thereof, and
   processing and drying the hydrogel in different form-stable articles e.g. beads granules, pellets, films etc. by casting, moulding, additive manufacturing, spinning etc. from micro to bulk sizes.
3. The phase change bio-complexes of embodiment 1 wherein the polysaccharide is storage derived from plants such as starch and guar gum.
4. The method of embodiment 2 wherein the polysaccharide is non-ionic derived from plants such as starch and guar gum.
5. The phase change bio-complexes of embodiment 1 wherein the polysaccharide is structural derived from plants such as cellulose pulp fibers.
6. The method of embodiment 2 wherein the polysaccharide is structural derived from plants such as cellulose pulp, comprising:
   dispersing pulp in water heated above e.g. 80° C. under homogeneous blending
   adding the PCM, acid from acetic acid, lactic acid, citric acid, or glyconic acid, and a water soluble di/multivalent metal salts to the dispersion.
   processing and drying the dispersion.
7. The phase change bio-complexes of embodiment 1 wherein the polysaccharide is structural derived from fungi and arthropods, crustaceans and insects, such as chitin particulates.
8. The method of embodiment 6 wherein the polysaccharide is structural derived from fungi and arthropods, crustaceans and insects, such as chitin particulates.
9. The phase change bio-complexes of embodiment 1 comprising from polysaccharide derivatives such as chitosan and carboxymethyl cellulose.
10. The method of embodiment 2 wherein the polysaccharide is a polysaccharide derivative such as chitosan, thereof
   dissolving the polysaccharide derivative in dilute acidic aqueous solution, e.g. acetic acid, heated above e.g. 50° C. while mixing to obtain a homogeneous solution wherein the PCM and salt of an acid and/or water soluble di/multivalent metal salts are added, thereof and,
   processing and drying in different form-stable articles.
11. The phase change bio-complexes of embodiments 1, 3, 5, 7, and 9, wherein a combination of polysaccharides is used.
12. The phase change bio-complexes of embodiments 1, 3, 5, 7, 9 and 11, said being charged with heat at a constant melting temperature forming a thermally and structurally resilient physical soft matter, said the soft matter having a homogeneous and uniform structure without the leakage of the complexed PCM, said the stored heat is discharged by crystallization of the stabilized PCM at a desired constant temperature which can be tuned by the ionic agent.
13. The phase change bio-complexes of embodiments 1, 3, 5, 7, 9, and 11 wherein polyethylene glycol is used as the complexed PCM with polysaccharides.
14. Sustainable phase change bio-complexes characterized by stable thermal and structural properties, thereof
   the phase change bio-complexes wherein the polysaccharide is from one or combination polysaccharides from the structural, storage, bacterial categories etc.
   the phase change bio-complexes of embodiment 14 wherein the complexed phase change material (PCM) with the polysaccharide is from fatty acids
   the phase change bio-complexes of embodiment 14 wherein di/multivalent cations including alkaline earth metals such as Ca, Mg and transition metals such as Fe, Zn, Al etc. and/or salts an acid such as citric acid e.g. sodium citrate, sodium tripolyphosphate etc. are added as ionic crosslinker for structural stabilization.
15. A simple preparation method of the phase change bio-complexes of embodiment 14, which the method comprises:
   dissolving/dispersing the polysaccharide in water heated above while mixing to obtain a homogeneous solution/dispersion
   dissolving the PCM in a suitable solvent e.g. weakly polar organic solvents such as ethanol, thereof and
   combining the PCM solution with polysaccharide solution/dispersion while mixing, preferably the ratio of water for dissolving polysaccharide and the solvent for the PCM need to be adjusted accordingly to avoid precipitation of the PCM during preparation and processing, thereof and
   salt of an acid e.g. sodium citrate and/or water soluble di/multivalent metal salts with an acid from acetic acid, lactic acid, citric acid, or glyconic acid, are added, thereof and
   processing and drying in different form-stable articles e.g. beads granules, pellets, films etc. by casting, moulding, printing, spinning etc. from micro to bulk sizes.
16. The phase change bio-complexes claimed above used in highly concentrated liquids, gels and/or fully dehydrated forms.
17. The application of the phase change bio-complexes claimed above for thermal management purposes i.e. cold and heat storage and thermal protection via heat absorbing-releasing, for instance in constructions, packaging, electronics, temperature sensitive items (black boxes), tree wraps and wearables.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated.

Furthermore, it is to be understood that the use of “a” or “an”, i.e. a singular form, throughout this document does not exclude a plurality.

### INDUSTRIAL APPLICABILITY

The present materials comprising phase change bio-complexes can be applied in different form-stable formats, such as powders, films, pellets, sheets, beads, sponges, for thermal management purposes including thermal energy storage and thermal protection via heat absorbing-releasing, for instance, in building, packaging, electronics, temperature sensitive items (black boxes) and wearables. In particular the phase change bio-complexes can be used in the form of highly concentrated liquids, gels and/or in fully dehydrated form.

### CITATION LIST

[1] R. Lapasin, S. Pricl, Industrial applications of polysaccharides, Rheology of Industrial Polysaccharides: Theory and Applications, Springer, Boston, Mass., 1995.
[2] S. N. Pawar, K. J. Edgar, Alginate derivatization: A review of chemistry, properties and applications, Biomaterials 33 (2012) 3279-3305.
[3] J. Liu, Q. Zhang, Z.-Y. Wu, J.-H. Wu, J.-T. Li, L. Huanga, S.-G. Sun, A high-performance alginate hydrogel binder for the Si/C anode of a Li-ion battery, Chemical Communication 50 (2014) 6386-6389.
[4] P. S. Gils, D. Ray, P. K. Sahoo, Characteristics of xanthan gum-based biodegradable superporous hydrogel, International Journal of Biological Macromolecules 45 (2009) 364-371.
[5] J.-i. Kadokawa, M.-a. Murakami, A. Takegawa, Y. Kaneko, Preparation of cellulose-starch composite gel and fibrous material from a mixture of the polysaccharides in ionic liquid, Carbohydrate Polymers 75 (2009) 180-183.
[6] M. Rinaudo, Chitin and chitosan: Properties and applications, Progress in Polymer Science 31 (2006) 603-632.
[7] D. Klemm, B. Heublein, H.-P. Fink, A. Bohn, Cellulose: Fascinating Biopolymer and Sustainable Raw Material, Angewandte Chemie International Edition 44 (2005) 3358-3393.
[8] M. R. Yazdani, E. Virolainen, K. Conley, R. Vahala, Chitosan-Zinc(II) complexes as a bio-sorbent for the adsorptive abatement of phosphate: mechanism of complexation and assessment of adsorption performance, Polymers 10 (2018) 25.
[9] M. R. Yazdani, A. Bhatnagar, R. Vahala, Synthesis, characterization and exploitation of nano-TiO2/feldsparembedded chitosan beads towards UV-assisted adsorptive abatement of aqueous arsenic (As), Chemical Engineering Journal 316 (2017) 370-382.
[10] D. Nataraj, S. Sakkara, M. Meghwal, N. Reddy, Crosslinked chitosan films with controllable properties for commercial applications, International Journal of Biological Macromolecules 120 (2018) 1256-1264.
[11] F. Hajji, Engineering renewable cellulosic thermoplastics, Reviews in Environmental Science and Bio/Technology 10 (2011) 25-30.
[12] S. Sundararajan, A. B. Samui, P. S. Kulkarni, Shape-stabilized poly(ethylene glycol) (PEG)-cellulose acetate blend preparation with superior PEG loading via microwave-assisted blending, Solar Energy 144 (2017) 32-39.
[13] B. Zalba, J. M. M. a, L. F. Cabeza, H. Mehling, Review on thermal energy storage with phase change: materials, heat transfer analysis and applications, Applied Thermal Engineering 23 (2003) 251-283.
[14] M. K. Rathod, J. Banerjee, Thermal stability of phase change materials used in latent heat energy storage systems: A review, Renewable and Sustainable Energy Reviews 18 (2013) 246-258.
[15] E. Rodriguez-Ubinas, L. Ruiz-Valero, S. Vega, J. Neila, Applications of Phase Change Material in highly energy-efficient houses, Energy and Buildings 50 (2012) 49-62.
[16] M. M. Farid, A. M. Khudhair, S. A. K. Razack, S. Al-Hallaj, A review on phase change energy storage: materials and applications, Energy Conversion and Management 45 (2004) 1597-1615.
[17] P. Lv, C. Liu, Z. Rao, Review on clay mineral-based form-stable phase change materials: Preparation, characterization and applications, Renewable and Sustainable Energy Reviews 68 (2017) 707-726.
[18] X. Huang, X. Chen, A. Li, D. Atinafu, H. Gao, W. Dong, G. Wang, Shape-stabilized phase change materials based on porous supports for thermal energy storage applications, Chemical Engineering Journal 356 (2019) 641-661.
[19] M. H. Hartmann, Stable phase change materials for use in temperature regulating synthetic fibers, fabrics and textiles, United States, 2004.
[20] T. M. Buckley, Flexible composite material with phase change thermal storage, United States 2001.
[21] L. P. Rolland, R. J. C. Reisdorf, Phase change material (pcm) compositions for thermal management, European 2012.
[22] H. Kakiuchi, M. Yamazaki, S. Chihara, Y. Terunuma, Y. Sakata, Heat storage/heat radiation method, United States, 1999.
[23] H. Kakiuchi, S. Chihara, M. Yamazaki, T. Isaki, Heat storage material composition, United States, 1998.
[24] S. Frohlich, H. Jochen, K. Salyer, Food warning device containing a rechargeable phase change material, United States, 1999.
[25] I. O. Salyer, Dry powder mixes comprising phase change materials, United States, 1993.
[26] M. Neuschutz, R. Glausch, Use of PCMs in heat sinks for electronic components United States, 2002.
[27] J. B. Zimmerman, P. T. Anastas, H. C. Erythropel, W. Leitner, Designing for a green chemistry future, Science 367 (2020) 397.
[28] S. Rosalam, R. England, Review of xanthan gum production from unmodified starches by Xanthomonas comprestris sp, Enzyme and Microbial Technology 39 (2006) 197-207.
[29] J. W. Thornton, B. Schraven, H. J. Thiewes, D. L. V. Brussel-Verreast, L. Bemporad, A.-M. Y. W. Verwiiligen, A. C. Besemer, P. Kalentuin, Acidic superabsorbent polysaccharides United States, 2004.
[30] D. Stroumpoulis, A. Tezel, Tunably crosslinked polysaccharide compositions, United States, 2013.
[31] Y. Zhao, H. Su, L. Fang, T. Tan, Superabsorbent hydrogels from poly(aspartic acid) with salt-, temperature- and pH-responsiveness properties, Polymer 46 (2005) 5368-5376.
[32] X. Z. Shu, K. J. Zhu, W. Song, Novel pH-sensitive citrate cross-linked chitosan film for drug controlled release, International Journal of Pharmaceutics 212 (2001) 19-28.
[33] T. Bechtold, A. P. Manian, H. B. Öztürk, U. Paul, B. Široká, J. Široký, H. Soliman, L. T. T. Vo, H. Vu-Manh, Ion-interactions as driving force in polysaccharide assembly, Carbohydrate Polymers 93 (2013) 316-323.
[34] T. C. Maloney, H. Paulapuro, P. Stenius, Hydration and swelling of pulp fibers measured with differential scanning calorimetry, Nordic Pulp and Paper Research Journal 13 (1) (1998) 31-36.

1. A phase-change complex comprising a phase change material complexed with a polysaccharide.

2. The phase-change complex according to claim 1, wherein the polysaccharide is selected from the group consisting of polysaccharides derived from microorganisms; storage polysaccharides derived from plants; structural polysaccharides derived from plants; structural polysaccharides derived from fungi or arthropods, crustaceans or insects; and polysaccharide derivatives; and combinations thereof.

3. The phase-change complex according to claim 1, wherein the phase change material is selected from the group consisting of sugar alcohols, mixtures of sugar alcohols, salt hydrates, polyethylene glycol, and combinations thereof.

4. The phase-change complex according to claim 1, further comprising at least one ionic agent, said at last one iconic agent comprising at least one salt, said salt being selected from the group consisting of salts comprising di- and multivalent cations or transition metals; and alkali metal salts of organic acids, or polymeric oxyanions.

5. The phase-change complex according to claim 1, the phase-change complex having a homogeneous and uniform structure and capable of discharging heat upon crystallization of the phase-change complex.

6. The phase-change complex according to claim 5, arranged to be charged with heat at a constant melting temperature so as to form a thermally and structurally resilient physical soft matter, said soft matter having a homogeneous and uniform structure without leakage of the complexed phase-change material.

7. The phase-change complex according to claim 1, wherein the phase-change material comprises member selected from the consisting of erythritol, dulcitol, mannitol, glycerol, sorbitol, xylitol, polyethylene glycol, sodium acetate trihydrate, sodium carbonate, decahydrate, and mixtures thereof.

8. The phase-change complex according to claim 1, wherein the polysaccharide is selected from the group consisting, of starch, guar gum, alginic acid, xanthan gum, chitosan, chitin particles, pulp, cellulose fibres, and combinations thereof.

9. The phase-change complex according to claim 1, comprising 5 to 50% by weight of the total weight of the complex of the polysaccharide and up to 20% by weight of the total weight of the complex of an ionic agent, wherein the remainder comprises the phase-change complex.

10. The phase-change complex according to claim 1, wherein the phase-change complex is ionically cross-linked.

11. A method of preparing the phase-change complex according to claim 1, the method comprising the steps of:
dissolving a polysaccharide in water to provide a homogeneous solution;
adding into said homogenous solution, under mixing, a phase change material optionally together with at least one salt to form a hydrogel;
drying the hydrogel; and
processing it into one or more form-stable articles.

12. The method according to claim 11, comprising dissolving the polysaccharide in water under mixing and heating.

13. The method according to claim 11, comprising providing the one or more form-stable articles in the shape of beads, granules, pellets, or films, by a method selected from the group consisting of casting, moulding, additive manufacturing, spinning and combinations thereof.

14. The method according to claim 11, wherein the polysaccharide is a structural polymer derived from plants, said method comprising:
dispersing pulp in water heated to a temperature of more than 50° C., under homogeneous blending to form a dispersion;
adding the phase-change material together with an acid selected from the group consisting of acetic acid, lactic acid, citric acid, glyconic acid, and combinations thereof, and at least one water soluble di- or multivalent metal salt to the dispersion; and
processing and drying the dispersion.

15. The method according to claim 11, wherein the polysaccharide is a polysaccharide derivative, said method comprising
dissolving the polysaccharide derivative in an acidic aqueous solution heated to a temperature above 50° C., while mixing to obtain a homogeneous solution,
adding the phase-change material and a salt of an acid and/or water soluble di/multivalent metal salts, and,
processing and drying to form the one or more form-stable articles.

16. A phase change bio-complex, comprising
at least one polysaccharide selected from polysaccharides of one or more of the structural, storage and bacterial categories;
a complexed phase change material selected from fatty acids; and optionally
ionic cross-linkers derived from the group of di/multivalent cations and/or salts of an acid.

17. A method of preparing the phase change bio-complex of claim 16, comprising:
dissolving or dispersing the at least one polysaccharide in water heated above while mixing to obtain a homogeneous solution or dispersion;
dissolving the phase-change material in a solvent;
combining the phase-change material containing solution with the polysaccharide solution or dispersion while mixing,
optionally adjusting the ratio of water for dissolving polysaccharide and the solvent for the phase-change material to avoid precipitation of the phase-change material during preparation and processing, thereof and optionally
adding a salt of an acid and/or a water soluble di/multivalent metal salts of an acid, selected from the group consisting of acetic acid, lactic acid, citric acid, and glyconic acid; and
processing and drying into one or more form-stable articles by casting, moulding, printing, or spinning.

18. The phase change bio-complex according to claim 16, wherein the phase change bio-complex is in the form of a concentrated liquid or gel, or in fully dehydrated forms.

19. (canceled)
